(19) United States
(12) Patent Application Publication
(10) Pub. No.: US 2026/0334504 A1
(43) Pub. Date: Oct. 29, 2026

(54) Uncoated Dairy Product

(71) Applicant: General Mills, Inc., Minneapolis, MN (US)

(72) Inventor: Andreas Schopf, Lyon (FR)

(73) Assignee: General Mills, Inc., Minneapolis, MN (US)

(21) Appl. No.: 19/735,611

(22) Filed: Jul. 9, 2026

Related U.S. Application Data
(62) Division of application No. 17/277,363, filed on Oct. 1, 2018, now Pat. No. 12,727,607.

(51) Int. Cl. A23G 9/48; A23G 9/42; A23G 9/50

(52) U.S. Cl. CPC A23G 9/48; A23G 9/42; A23G 9/503; A23V 2002/00

(57) ABSTRACT

Uncoated frozen dairy products and methods of making such uncoated frozen dairy products are disclosed herein. Uncoated frozen dairy products have an acidified surface layer, contain substantially no stabilizers or emulsifiers, are structurally unsupported, and exhibit a product loss of less than 30% over 60 minutes at a temperature of 25 °C.

### CROSS-REFERENCE TO RELATED APPLICATIONS

This application represents a divisional of U.S. patent application Ser. No. 17/277,363, filed Mar. 18, 2021, entitled “Uncoated Dairy Product”, pending, which represents a National stage application of PCT/IB2018/001326, filed Oct. 1, 2018, entitled “Uncoated Dairy Product”, expired. The entire content of these applications are incorporated by reference.

### BACKGROUND OF THE INVENTION

Consumers often seek novel eating experiences, especially with foods that are considered treats, such as ice cream. A trending eating experience with ice cream, and other frozen dairy products, includes portable eating experience, such as hand-held ice cream and stick bars (e.g., ice cream on a wooden or plastic stick). In many cases, complex ingredient combinations can provide sufficient stability to a frozen dairy product to allow for consumers to enjoy portable frozen dairy products. However, there is a need for portable frozen dairy product options with more simple ingredients.

### SUMMARY

Provided herein is an uncoated frozen dairy product. An uncoated frozen dairy product provided herein has a product loss of less than 30% over 60 minutes at a temperature of 25 °C, is structurally unsupported, has an acidified surface layer, and contains substantially no stabilizers or emulsifiers.

In some embodiments an uncoated frozen dairy product can have a product loss of less than 30% over 80 minutes at a temperature of 25 °C

In some embodiments, the acidified surface layer of an uncoated frozen dairy product includes a fruit juice containing an organic acid.

In some embodiments, a frozen dairy product provided herein can be an ice cream.

In some embodiments, a frozen dairy product provided herein can be a stick bar product.

Also provided herein is a method of making an uncoated frozen dairy product having a product loss of less than 30% over 60 minutes at a temperature of 25 °C. A method provided herein includes applying an organic acid solution having a pH of less than 2.7 to the surface of a frozen dairy mass containing substantially no stabilizers or emulsifiers to make the uncoated frozen dairy product, wherein the uncoated frozen dairy product is structurally unsupported.

In some embodiments, an organic acid solution used in a method provided herein can have a pH of 2.6 or less. In some embodiments, an organic acid solution used in a method provided herein can have a pH of 2.3 or less.

In some embodiments of a method provided herein, the organic acid solution can include lemon juice.

In some embodiments of a method provided herein, applying the organic acid solution can include dipping the frozen dairy mass into the organic acid solution. In some embodiments of a method provided herein, applying the organic acid solution can include spraying the organic acid solution on the surface of the frozen dairy mass.

In some embodiments of a method provided herein, the method can further include subjecting the frozen dairy product to a temperature of 0 °C or less.

In some embodiments of a method provided herein, the method can further include packaging the frozen dairy product.

In some embodiments of a method provided herein, the frozen dairy mass can be an ice cream.

In some embodiments of a method provided herein, the frozen dairy mass can be a stick bar product.

Additional objects, features and advantages of the invention will become more readily apparent from the following detailed description when taken in conjunction with the drawings wherein like reference numerals refer to corresponding parts in the several views.

### BRIEF DESCRIPTION OF THE DRAWINGS

FIG. 1 is a graph comparing product loss rates of an uncoated frozen dairy product made by dipping frozen dairy masses in organic acid solutions at varying pH levels.

FIG. 2 is a graph comparing product loss rates of an uncoated frozen dairy product made by dipping frozen dairy masses in organic acid solutions at two pH levels to product loss rates of an uncoated frozen dairy product made by dipping frozen dairy masses in an inorganic acid solution (HCl).

### DETAILED DESCRIPTION

Consumers are increasingly looking for foods that provide enjoyable eating experiences with simpler ingredients. Ingredients that consumers are more likely to avoid include stabilizers and emulsifiers. However, stabilizers and emulsifiers can provide structural and textural advantages to foods, and can be used to make portable frozen dairy products, such as ice cream (e.g., traditional and soft serve ice cream), frozen custard, frozen fudge, frozen mousse, ice milk, sherbet, and frozen yogurt, that are relatively stable at elevated temperatures. One way to achieve a portable frozen dairy product without relying on stabilizers or emulsifiers is to coat a frozen dairy portion in a fat-based or confectionary coating, such as a chocolate coating. However, some consumers would prefer to avoid the added fat of a coating, or avoid the flavor or texture of a coating.

It was discovered, and is described herein, that an organic acid can be applied to the surface of a frozen dairy mass that contains substantially no stabilizers or emulsifiers to achieve a unique uncoated, structurally unsupported frozen dairy product that has reduced product loss at elevated temperatures. As used herein, a frozen dairy product having “substantially no stabilizers or emulsifiers” refers to a frozen dairy product that contains no added ingredients that contribute to structural stability, other than milk ingredients (e.g., whole milk, low fat milk, skim milk, cream, or the like), natural sweeteners (e.g., sucrose, honey, maple syrup, stevia extract, and the like), egg ingredients (e.g., whole egg, egg white, or egg yolk), fruit ingredients (e.g., fruit puree, fruit pieces, fruit juices, and the like), natural flavors (e.g., vanilla bean, vanilla extract, cocoa, and the like), inclusions (e.g., nut or nut pieces, chocolate pieces, or the like), or organic acids as described below.

In addition to avoiding stabilizers and emulsifiers, as well as fat-based coatings, this discovery provides a unique aspect of providing the consumer a product that displays the frozen dairy product as uncoated and structurally unsupported. As used herein, the term “uncoated” refers to a frozen dairy product that does not have a fat-based or confectionary coating. As used herein, the term “structurally unsupported” refers to a frozen dairy product that substantially retains its shape in the absence of an exterior packaging or other external support structure other than an acidified surface layer. It is to be understood that a frozen dairy product provided herein can include an internal structure, such as a stick, while remaining structurally unsupported as defined herein. In addition, it is to be understood that a structurally unsupported frozen dairy product can be packaged for ease of transportation, sale, and for food safety purposes. However, a structurally unsupported frozen dairy product substantially retains its shape after being removed from any packaging.

The invention relates generally to an uncoated portable frozen dairy product containing substantially no stabilizers or emulsifiers. An uncoated portable frozen dairy product can be in any form, such as a stick bar (e.g., frozen dairy product on a stick), a frozen dairy bar, a frozen dairy cake, a frozen dairy sandwich, a frozen dairy bite, frozen dairy in a cone, and the like.

An uncoated frozen dairy product provided herein includes an acidified surface layer that contributes to a reduction in product loss at elevated temperatures. An uncoated frozen dairy product provided herein has a product loss of less than 30% (e.g., less than 25%, or less than 20%) over 60 minutes at a temperature of 25 °C. In some embodiments, an uncoated frozen dairy product can have a product loss of less than 30% over more than 60 minutes (e.g., at least 90 minutes, or at least 120 minutes) at 25 °C. As used herein, product loss is measured by placing an uncoated frozen dairy product mass having a known weight (e.g., from about 10 g to about 150 g, from about 15 g to about 100 g, or from about 50 g to about 80 g) on a #2 mesh size sieve placed over a container and held at 25 °C. At one or more selected time point (e.g., 60 minutes, 75 minutes, 90 minutes, or the like), the weight of uncoated frozen dairy product mass that flows away from the original uncoated frozen dairy product mass is measured in the container under the sieve. The amount of uncoated frozen dairy product mass that flows away as a percentage by weight of the original weight of the uncoated frozen dairy product mass is the product loss.

An acidified surface layer is formed by applying an organic acid solution to a surface of a frozen dairy product mass to produce an uncoated frozen dairy product provided herein. An organic acid solution suitable for applying to a frozen dairy product mass has a pH of 2.7 or less (e.g., less than 2.7, 2.6 or less, or 2.3 or less). Any organic acid is suitable for use in making an uncoated frozen dairy product provided herein. For example, fruit juices (e.g., lemon juice, cranberry juice, or the like), vinegars (e.g., apple cider vinegar, balsamic vinegar, or the like), or other solutions of organic acids (e.g., citric acid, acetic acid, malic acid, lactic acid, or the like), or any combination thereof, can be used.

An organic acid solution can be applied to a surface of a frozen dairy product mass using any appropriate method, such as spraying or dipping the frozen ice cream mass. For example, a frozen dairy product mass on a stick can be dipped in a lemon juice to achieve an acidified layer on a surface. An organic acid solution applied to a frozen dairy product mass can have a temperature of from about 20 °C to about 40 °C (e.g., from about 25 °C to about 30 °C).

A frozen dairy product mass can have a temperature of −20 °C or less (e.g., from −20 °C to −50 °C) at the time an organic acid solution is applied to a surface. A frozen dairy product can have any appropriate mass and volume. In some embodiments frozen dairy product mass can have a weight of from about 10 g to about 200 g. For example, a frozen dairy bar can have a weight of from about 30 g to about 80 g, or bite sized frozen dairy pieces can have a weight of from about 10 g to about 25 g, or a frozen dairy cake can weigh from about 100 g to about 200 g. In some embodiments, a frozen dairy product can have a volume of from about 10 ml to about 150 ml. For example, a stick bar can have a volume of around 70 to 80 ml, while frozen dairy bites can have a volume of about 10 ml to about 15 ml.

Without being bound to theory, it is believed that an organic acid causes denaturation of milk proteins on the surface of a frozen dairy product mass to achieve a layer on the surface that can prevent inner, non-acidified portions of the ice cream from flowing off of the ice cream mass. Non-organic acids, such as hydrochloric acid, even at the same pH, do not achieve this effect. Without being bound by theory, it is believed that the slower reaction kinetics of organic acids can achieve a protective surface layer on ice cream because the organic acid can penetrate the surface sufficiently before denaturing milk proteins such that a thicker layer of denatured proteins is formed. In contrast, it is believed that inorganic acids, such as hydrochloric acid may denature proteins so quickly that further penetration of the acid is prevented by a thin layer of denatured proteins, which is not thick enough to protect an ice cream mass (e.g., at least 0.5 mm, at least 0.7 mm, or at least 1 mm).

In some embodiments, following application of an organic acid solution, an uncoated frozen dairy product can be subjected to a temperature of 0 °C or less (e.g., less than −20 °C, −30 °C or less, or −40 °C or less). In some embodiments, an uncoated frozen dairy product can be packaged in any suitable packaging. Although an uncoated frozen dairy product provided herein has reduced product loss at elevated temperatures, it is preferred that the product be stored a temperature of less than 4 °C (e.g., 0 °C or less). However, it is to be understood that storage, shipping, and handling temperatures need not be ideal, so an uncoated frozen dairy product provided herein may be subjected to temperatures at or above 4 °C.

Frozen dairy products suitable for use as a frozen dairy product mass in methods provided herein to produce an uncoated frozen dairy product can include frozen dairy products with simple ingredient combinations, without measurable amounts of stabilizers or emulsifiers, as defined herein.

### EXAMPLES

### Example 1

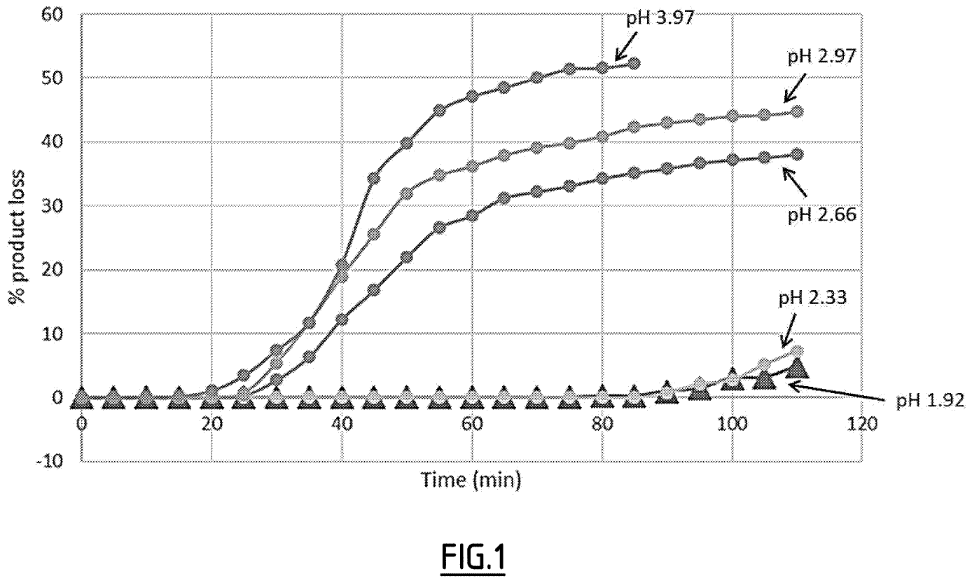

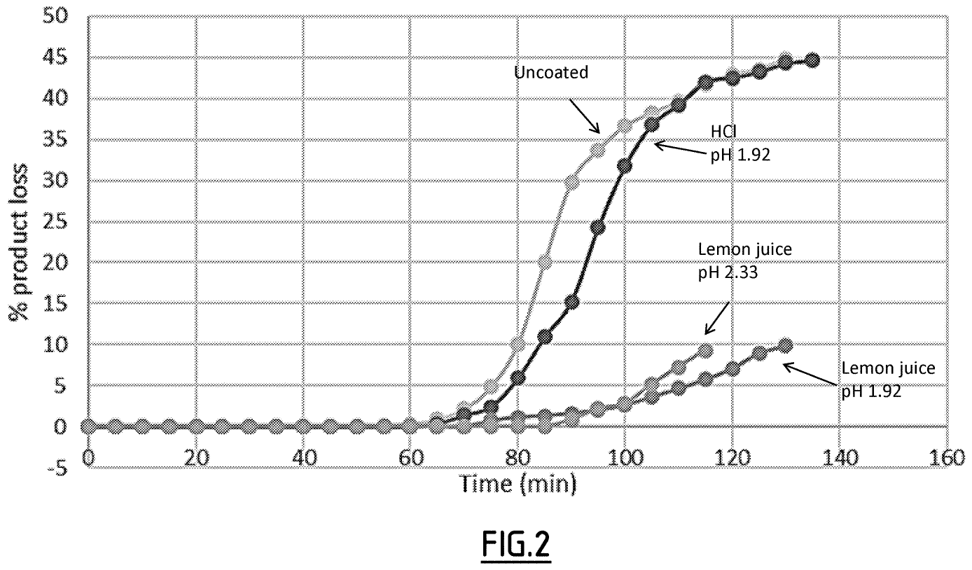

An ice cream product was produced with milk, cream, egg, sugar, and vanilla extract, and frozen in molds to produce frozen dairy masses having a weight of about 70 g each. The ice cream masses were either left untreated, dipped in water, dipped in a hydrochloric acid (HCl) solution (pH 1.92), or dipped in a lemon juice solution (pH 1.92, pH 2.33, pH 2.66, pH 2.97, or pH 3.97). Each ice cream product was at a temperature of about- 40 °C prior to dipping, and each dipping treatment was at a temperature of about 25 °C to about 30 °C. After dipping, the treated masses were stored at −23 °C for 3 days prior to measuring product loss. Product loss was measured as described above. Dipping in water yielded similar results as leaving the ice cream product uncoated. FIG. 1 shows product loss over time for each of the masses treated with lemon juice. As can be seen in FIG. 1, masses treated with lemon juice at a pH below 2.7 had a distinctly improved product loss profile. As can be seen in FIG. 2, where lemon juice treatment is compared to HCl treatment and water treatment, organic acid provides an improved product loss profile over HCl.

Other embodiments of this invention will be apparent to those skilled in the art upon consideration of this specification or from practice of the invention disclosed herein. Various omissions, modifications, and changes to the principles and embodiments described herein may be made by one skilled in the art without departing from the true scope and spirit of the invention which is indicated by the following claims.

What is claimed is:

1. An uncoated frozen dairy product having a product loss of less than 30% over 60 minutes at a temperature of 25 °C, the uncoated frozen dairy product being structurally unsupported, having an acidified surface layer, and containing substantially no stabilizers or emulsifiers.

2. The uncoated frozen dairy product of claim 1, wherein the frozen dairy product has a product loss of less than 30% over 80 minutes at a temperature of 25 °C.

3. The uncoated frozen dairy product of claim 1, wherein the acidified surface layer comprises a fruit juice containing an organic acid.

4. The uncoated frozen dairy product of claim 1, wherein the frozen dairy product is an ice cream.

5. The uncoated frozen dairy product of claim 1, wherein the frozen dairy product is a stick bar product.
